(19) United States
(12) Patent Application Publication
(10) Pub. No.: US 2026/0241831 A1
(43) Pub. Date: Aug. 20, 2026

(54) VEHICLE CHARGING SYSTEM

(71) Applicant: Electric Era Technologies Inc., Seattle, WA (US)

(72) Inventors: Quincy Lee, Seattle, WA (US); Sam Reineman, Kirkland, WA (US); Hasitha Dharmasiri, Seattle, WA (US)

(21) Appl. No.: 19/055,135

(22) Filed: Feb. 17, 2025

(51) Int. Cl. B60L 53/68; B60L 53/18; G06V 10/764; G06V 20/52; G10L 15/18; G10L 15/22

(52) U.S. Cl. CPC B60L 53/68; B60L 53/18; G06V 10/764; G06V 20/52; G10L 15/18; G10L 15/22; G10L 2015/223

(57) ABSTRACT

A charging network includes a charging station configured to electrically couple a vehicle with a power source. The charging station includes a housing and a user interface operably coupled with the housing. The user interface may include an image sensor, an audio sensor, a display, and/or a speaker. A computing system is operably coupled with the user interface. The computing system includes a processor and associated memory. The memory stores instructions that, when implemented by the processor, configure the computing system to receive a first set of the image data and a first set of the audio data, determine a first set of one or more outputs based at least on the first set of the image data and the first set of the audio data, and generate a first set of one or more instructions based on the first set of one or more outputs.

### FIELD OF THE INVENTION

The present disclosure generally relates to charging systems, which may be implemented at one or more remote sites (or access locations).

### BACKGROUND OF THE INVENTION

In general, electric vehicle (EV) charging systems may be implemented in various locations. Some locations of the charging system may be in close proximity to other places of interest, such as convenience stores. As such, charging systems that may provide additional information regarding the charger, the places of interest, and/or any other information would be welcomed by the industry.

### SUMMARY OF THE INVENTION

Aspects and advantages of the invention will be set forth in part in the following description, or may be obvious from the description, or may be learned through practice of the invention.

According to some aspects of the present disclosure, a charging network that includes a charging station configured to electrically couple a vehicle with a power source. The charging station includes a housing and a user interface operably coupled with the housing. The user interface includes an image sensor configured to capture image data of a defined environment, an audio sensor configured to capture audio data, and a display. A computing system is operably coupled with the user interface. The computing system includes a processor and associated memory, the memory storing instructions that, when implemented by the processor, configure the computing system to receive the image data and the audio data, determine one or more outputs based at least on the image data and the audio data, and generate one or more instructions for the display based on the one or more outputs. The one or more instructions cause the display to illustrate a defined graphic.

According to some aspects of the present disclosure, a method for operating a charging network includes capturing, with an image sensor operably coupled with a charging station, image data of a defined environment. The method also includes determining, with a local computing system, one or more outputs based at least on the image data. In addition, the method includes generating, with the computing system, instructions based on the one or more outputs.

According to some aspects of the present disclosure, a charging network that includes a charging station configured to electrically couple a vehicle with a power source. The charging station includes a housing and a user interface operably coupled with the housing. The user interface includes an image sensor configured to capture image data of a defined environment, an audio sensor configured to capture audio data, a display configured to illustrate one or more images, and a speaker configured to generate one more audio signals. A computing system is operably coupled with the user interface. The computing system includes a processor and associated memory, the memory storing instructions that, when implemented by the processor, configure the computing system to receive a first set of the image data and a first set of the audio data, determine a first set of one or more outputs based at least on the first set of the image data and the first set of the audio data, and generate a first set of one or more instructions based on the first set of one or more outputs, wherein the first set of one or more instructions cause the display to illustrate a defined graphic or the speaker to output an audio signal.

These and other features, aspects, and advantages of the present technology will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 is a schematic view of a charging network according to some aspects of the present disclosure;

FIG. 2 is a schematic view of three charging stations operably coupled with a site-based computing system according to some aspects of the present disclosure;

FIG. 3 is a perspective view of a charging system according to some aspects of the present disclosure;

FIG. 4 is a block diagram illustrating a plurality of charging systems operably coupled with a remote server in accordance with aspects of the present subject matter;

FIG. 5 is a schematic block diagram illustrating portions of the system of FIG. 1 in accordance with aspects of the present subject matter;

FIG. 6 illustrates a schematic view of a flow diagram for training a machine-learned model in accordance with aspects of the present subject matter; and

FIG. 7 is a method for operating the charging network in accordance with aspects of the present disclosure.

Repeat use of reference characters in the present specification and drawings is intended to represent the same or analogous features or elements of the present technology.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

As used herein, the terms “first,” “second,” and “third” may be used interchangeably to distinguish one component from another and are not intended to signify a location or importance of the individual components. Moreover, for purposes of convenience and clarity only, directional terms, such as top, bottom, left, right, up, down, over, above, below, beneath, rear, back, and front, may be used with respect to the accompanying drawings. These and similar directional terms should not be construed to limit the scope of the disclosure in any manner. Thus, it will be appreciated that the apparatus and/or any component described here may be oriented in one or more orientations that are rotationally offset from those illustrated without departing from the scope of the present disclosure.

The terms “coupled,” “fixed,” “attached to,” and the like refer to both direct coupling, fixing, or attaching, as well as indirect coupling, fixing, or attaching through one or more intermediate components or features unless otherwise specified herein. The terms “upstream” and “downstream” refer to the relative direction with respect to electrical power flow through a system. For example, “upstream” refers to the direction from which the electrical power flows, and “downstream” refers to the direction in which the electrical power flows. The term "selectively" refers to a component’s ability to operate in various states (e.g., an ON state and an OFF state) based on manual and/or automatic control of a component.

The singular forms “a,” “an,” and “the” include plural references unless the context clearly dictates otherwise. In addition, the term “each” may be used interchangeably with “any” for any feature described herein.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein will be considered exemplary.

Here and throughout the specification and claims, range limitations are combined, and interchanged, such ranges are identified and include all the sub-ranges contained therein unless context or language indicates otherwise. For example, all ranges disclosed herein are inclusive of the endpoints, and the endpoints are independently combinable with each other.

As used herein, the term “and/or,” when used in a list of two or more items, means that any one of the listed items may be employed by itself, or any combination of two or more of the listed items may be employed. For example, if a composition or assembly is described as containing components A, B, and/or C, the composition or assembly may contain A alone; B alone; C alone; A and B in combination; A and C in combination; B and C in combination; or A, B, and C in combination.

In general, the present subject matter is directed to a charging network that includes one or more charging systems for controlling various electric resources, such as an electric vehicle (EV) 14, at a defined location, such as an EV charging site. The charging stations are each configured to electrically couple a vehicle with a power source. The charging stations may include a user interface operably coupled with the housing. The user interface may allow for the charging system to communicate with one or more persons or other objects while within a defined range of the charging system. Additionally or alternatively, one or more persons or other objects may communicate with the charging system through the user interface while within a defined range of the charging system.

In various examples, the user interface may include an image sensor configured to capture image data of a defined environment, an audio sensor configured to capture audio data, a display configured to illustrate one or more images, a speaker configured to generate one more audio signals, point of sale (POS) terminal configured to initiate data transactions with a third party, and/or any other device.

A computing system may be operably coupled with the user interface. The computing system may be configured to receive a first set of the image data and a first set of the audio data, determine a first set of one or more outputs based at least on the first set of the image data and the first set of the audio data, and generate a first set of one or more instructions based on the first set of one or more outputs. The instructions control one or more components of the user interface. In some cases, the computing system may further be configured to receive a second set of the image data after the first set of the image data and a second set of the audio data after the first set of the audio data, determine a second set of one or more outputs based at least on the first set of one or more outputs, the second set of the image data, and the second set of the audio data, and generate a second set of one or more instructions based on the second set of one or more outputs. Moreover, the computing system may further be configured to transmit at least one of the first set of one or more outputs, or the second set of one or more outputs is transmitted to a third party.

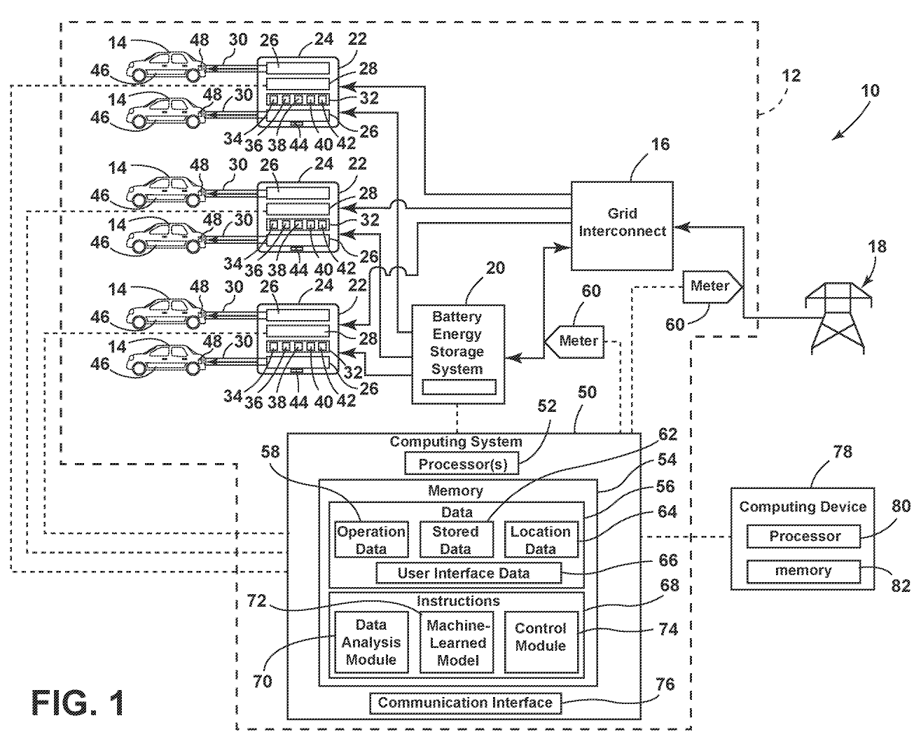

Referring now to FIG. 1, in some embodiments, a charging network 10 that includes one or more charging systems 12 for controlling various electric resources, such as an electric vehicle (EV) 14, at a defined location, such as an EV charging site is provided in accordance with various aspects of the present disclosure. For clarity purposes, solid connection lines in FIG. 1 indicate an energy transfer line between two components described herein and dashed lines illustrate communication lines between two components described herein. Moreover, “electric resource” as used herein typically refers to electrical entities that may be commanded to do some or all of these three things: take power (act as load), provide power (act as power generation or source), and store energy. Examples may include battery/charger/inverter systems for electric or hybrid-electric vehicles, repositories of used-but-serviceable electric vehicle batteries, fixed energy storage, fuel cell generators, emergency generators, controllable loads, etc. “Electric vehicle” is used broadly herein to refer to pure electric and hybrid electric vehicles, such as plug-in hybrid electric vehicles (PHEVs), especially vehicles that have significant storage battery capacity and that connect to a power grid for recharging the battery. More specifically, an electric vehicle is a vehicle that gets some or all of its energy for motion and other purposes from the power grid. Moreover, an electric vehicle has an energy storage system, which may consist of batteries, capacitors, etc., or some combination thereof. An electric vehicle may or may not have the capability to provide power back to the electric grid. It will be appreciated that the charging system 12 provided herein may be implemented and used in any location with any object that may be charged and/or accept electricity for operation thereof.

As illustrated, the charging system 12 may include a grid interconnect 16 that may be operably coupled with a power grid 18. The “power grid” as used herein means a power distribution system/network that connects producers of power with consumers of power. The network may include generators, transformers, interconnects, switching stations, and safety equipment as part of either/both the transmission system (i.e., bulk power) or the distribution system (i.e. retail power). The power aggregation system is vertically scalable for use within a neighborhood, a city, a sector, a control area, or (for example) one of the eight large-scale Interconnects in the North American Electric Reliability Council (NERC). Moreover, the system is horizontally scalable for use in providing power services to multiple grid areas simultaneously.

The charging system 12 may also include a battery energy storage system 20, which may be operably coupled with the grid interconnect 16. The battery energy storage system 20 may consist of one or more batteries configured in a series, parallel, or combination of series and parallel connections. In various examples, the battery energy storage system 20 may have a nominal voltage of up to 800 volts (V) and may store 200 kilo-Watt-hours (kWh) of energy. As illustrated, the battery energy storage system 20 may transfer power stored therein to one or more charging stations 22 and/or to the grid interconnect 16 so that the power may be provided to the grid 18. As such, in some examples, the battery energy storage system 20 may include power electronic components to form a bi-directional AC-DC converter-inverter that may both convert AC to DC and invert DC to AC using the same circuit topography. Additionally or alternatively, multiple inverters/converters may be implemented without departing from the scope of the present disclosure.

In general, each charging system 12 may convert energy from the grid interconnect 16 and/or the battery energy storage system 20, using energy conversion techniques such as, but not limited to, DC to DC conversion, AC to DC conversion, DC to AC conversion, AC to AC conversion, current limiting and voltage regulation, as determined, at least in part, by the charging requirements of the EV 14 that is using power from the charger unit and/or requirements of the vehicle operator (e.g., the vehicle driver, owner, custodian or other person available to specify such requirements). Power may be provided from the charging station 22 to the EV 14 during a charging session that begins when the power is transferred from the charging station 22 to the EV 14 and ceases when power is no longer being transferred. In various instances, the amount of power may vary over time during the charging session as necessary to improve factors including, but not limited to, charger unit efficiency, charge time, battery life, and/or charging cost to the vehicle operator.

In various examples, each charging station 22 may include a housing 24. The housing 24 may include and/or be operably coupled with one or more power distribution assemblies 26 and/or a controller 28. In addition, the charging station 22 may include one more charging cables 30 that is operably supported by the housing 24 and electrically coupled with the one or more power distribution assemblies. In various instances, each charging station 22 may include a number of power distribution assemblies 26 that is equal to the number of power output cables of the charging station 22. For instance, in the example illustrated in FIG. 1, each charging station 22 includes first and second charging cables 30 and first and second power distribution assemblies 26. However, it will be appreciated that the charging station 22 may include any number of power output cables and/or power distribution assemblies 26 without departing from the scope of the present disclosure. In general, the power distribution assembly 26 may contain power electronic components to form a bi-directional AC-DC converter-inverter that may both convert AC to DC and invert DC to AC using the same circuit topography. A converter-inverter topography allows the charging system 12 to interchangeably and/or supplementarily use AC power from the grid 18 and/or DC power from the battery energy storage system 20 based on certain conditions, such as when power rates are low cost or when the percentage of renewable energy generation entering the grid 18 is high.

In general, the controller 28 may include any suitable processor-based device, such as a computing device or any suitable combination of computing devices. Thus, in several embodiments, the controller 28 may include one or more processor(s) and associated memory device(s) configured to perform a variety of computer-implemented functions. It will be appreciated that, in several embodiments, the controller 28 may correspond to an existing controller 28 of the charging station 22, or the controller 28 may correspond to a separate processing device.

In various examples, each charging station 22 may include and/or be operably coupled with a user interface 32. The user interface 32 may include an image sensor 34, an audio sensor 36, a speaker 38, a display 40, an input system 42, a point of sale (POS) system 44, and/or any other device. The user interface 32 may allow for the charging system 12 to communicate with one or more persons or other objects while within a defined range of the charging system 12. Additionally or alternatively, one or more persons or other objects may communicate with the charging system 12 through the user interface 32 while within a defined range of the charging system 12.

Each charging station 22 may be respectively coupled with an EV 14 (or other electric resource) for providing power thereto. In various examples, each participating EV 14 or group of local EVs 14 has a corresponding battery assembly 46 and/or a remote power management module 48. In various examples, the charging system 12 may communicate with the remote power management modules 48 distributed peripherally among the EVs 14. The remote power management module 48 may perform several different functions, including, but not limited to, providing the charging system 12 with the statuses of the remote EVs 14; controlling the amount, direction, and timing of power being transferred into or out of a remote EV 14; providing metering of power being transferred into or out of a remote EV 14; providing safety measures during power transfer and changes of conditions in the power grid 18; logging activities; and providing self-contained control of power transfer and safety measures when communication with the charging system 12 is interrupted.

Additionally, the charging system 12 may also include a site computing system 50. In general, the computing system 50 may correspond to any suitable processor-based device(s), such as a computing device or any combination of computing devices. Thus, as shown in FIG. 1, the computing system 50 may generally include one or more processors 52 and associated memory devices 54 configured to perform a variety of computer-implemented functions (e.g., performing the methods, steps, algorithms, calculations, and the like disclosed herein). As used herein, the term “processor” refers not only to integrated circuits referred to in the art as being included in a computer, but also refers to a controller, a microcontroller, a microcomputer, a programmable logic controller (PLC), an application-specific integrated circuit, and other programmable circuits. Additionally, the memory 54 may generally include memory element(s) including, but not limited to, computer-readable medium (e.g., random access memory (RAM)), computer-readable non-volatile medium (e.g., a flash memory), a floppy disk, a compact disc-read only memory (CD-ROM), a magneto-optical disk (MOD), a digital versatile disc (DVD) and/or other suitable memory elements. Such memory 54 may generally be configured to store information accessible to the processors 52, including data 56 that may be retrieved, manipulated, created, and/or stored by the processors 52 and instructions 68 that may be executed by the processors 52. While the computing system 50 is shown as a component of the charging system 12, it will be appreciated that the computing system 50 may be remote from the charging system 12 without departing from the scope of the present disclosure.

In several embodiments, the data 56 may be stored in one or more databases. For example, the memory 54 may include an operation database 58 for storing data received from one or more components of the charging system 12. For instance, as illustrated, one or more meters 60 may be operably coupled with various connection lines and the site computing system 50. Each meter 60 may be configured to measure the amount of electric energy in a defined location. In the example shown in FIG. 1, a first meter 60 may be operably coupled with a connection line between the grid 18 and the grid interconnect 16 (and/or any other position upstream of the grid interconnect 16). As such, the first meter 60 may be capable of measuring the power load that is being provided from the grid 18 to the grid interconnect 16. Additionally or alternatively, a second meter 60 may be operably coupled with a connection line between the grid interconnect 16 and the battery energy storage system 20. As such, the second meter 60 may be capable of measuring a power load that is being transferred from the grid interconnect 16 to the battery energy storage system 20, and/or from the battery energy storage system 20 to the grid interconnect 16. Additionally or alternatively, the controllers 28 of the one or more charging stations 22 may provide operational data to the computing system 50.

Additionally, as shown in FIG. 1, the memory 54 may include stored data in a stored database 62 that includes information or data associated with the charging system 12. The stored data may be calculated or determined by the computing system 50 based on any data accessible to the network 10 (e.g., including data accessed, received, or transmitted from internal data sources and/or external data sources) and/or received from an external source. Moreover, in several embodiments, the memory 54 may also include a location database 64 storing location information about the location of the charging system 12. Additionally or alternatively, in some examples, the memory 54 may include an input database 66 storing information that may be inputted and/or outputted from the user interface 32.

Referring still to FIG. 1, in several embodiments, the instructions 68 stored within the memory 54 of the computing system 50 may be executed by the processors 52 to implement a data analysis module 70. In general, the data analysis module 70 may be configured to analyze the data to determine one or more charging parameters (e.g., a power load, an energy source to supply the energy (e.g., the grid 18 and/or the battery energy storage system 20), a voltage, a current, an amount of time, and/or any other charging parameters) to the EV 14. In some instances, the data analysis module 70 may cooperatively operate with or otherwise leverage a machine-learned model 72 to analyze the data 56 to determine the one or more charging parameters. Additionally or alternatively, the data analysis module 70 may be configured to analyze the data to determine one or more outputs. The one or more determined outputs may be provided to the control module 74. In general, the control module 74 may be configured to generate instructions that adjust the operation of the charging system 12 by controlling one or more components of the charging system 12 based on the instructions.

Moreover, as shown in FIG. 1, the computing system 50 may also include a communications interface 76 to communicate with any of the various other system components described herein. For instance, one or more communicative links or interfaces (e.g., one or more data buses and/or wireless connections) may be provided between the communications interface 76 and the meters 60 to allow data transmitted from the meters 60 to be received by the computing system 50. Additionally, as shown in FIG. 1, one or more communicative links or interfaces (e.g., one or more data buses and/or wireless connections) may be provided between the communications interface 76 and the controllers 28 of the charging stations 22 and/or the battery energy storage system 20 to allow the computing system 50 to control the operation of such system components.

Additionally or alternatively, the communications interface 76 may also interface with one or more remote computing devices 78. In some instances, the computing device 78 may include one or more processor-based devices, such as a given controller or computing device or any suitable combination of controllers or computing devices. Thus, in several embodiments, the computing device 78 may include one or more processor(s), and the associated memory 82 configured to perform a variety of computer-implemented functions. Additionally, the memory 82 of the computing device 78 may generally be configured to store suitable computer-readable instructions that, when implemented by the processors 80, configure the computing device 78 to perform various computer-implemented functions, such as one or more aspects of the methods and algorithms that will be described herein. In addition, the computing device 78 may also include various other suitable components, such as a communications circuit or module, one or more input/output channels, a data/control bus, and/or the like. It should be appreciated that the various functions of the computing device 78 may be performed by a single processor-based device or may be distributed across any number of processor-based devices, in which instance such devices may be considered to form part of the computing device 78.

In operation, the computing system 50 may receive input data, which may be received from the image sensor 34, the audio sensor 36, the point of sale (POS) system 44, the input system 42, and/or any other device. Additionally or alternatively, the computing system 50 may receive any other data. In turn, the data analysis module 70 of the computing system 50 may generate one or more determined outputs for the control module 74. With the computing system 50 being onsite with the charging system 12, the outputs may be generated with low latency as at least a portion of the data and at least a portion of the processing is completed onsite. The control module 74 may generate instructions to operate one or more components of the charging system 12 based on the one or more determined outputs. For instance, the control module 74 may output instructions through the user interface 32 and/or any other component of the charging system 12. The instructions may allow the user interface 32 to provide information that is relevant to a person within a defined distance of the charging system 12, a person operating the charging system 12, a person that is remote from the charging system 12, and/or any other person. In some cases, the instructions may include the cost of power from the charging system 12, cost of any other service that may be provided through the charging system 12, information related to products that are available at places of interest (e.g., a convenience store, a retailer, a professional service, etc.) within defined distances of the charging system 12, information related to and/or fillable applications for various loyalty programs and/or membership programs, providing information related to the charging system 12, information related to the EV 14 operably coupled or to be operably coupled with the charging system 12, instructions related to the locality in which the charging system 12 is located, information related to the security of the charging system 12 and/or a vehicle (or another object) within a defined distance of the charging system 12, information related to feedback from an operator of the charging system 12, and/or any other information. In some instances, the computing system 50 may store or include one or more models, which may be machine-learned models 72. For example, the machine-learned model 72 may be a machine-learned output information model. In various examples, the machine-learned output information model may be configured to receive the input data and process input data to determine one or more outputs, which is provided to the control module 74 is that instructions for one or more components may be provided to such components.

Additionally or alternatively, the data analysis module 70 of the computing system 50 may predict vehicle flow and expected power load over defined periods. Additionally or alternatively, the data from the charging system 12 may be provided to the remote computing device 78, which then predicts vehicle flow and expected power load over defined periods for one or more charging systems 12. Additionally or alternatively, the data analysis module 70 may leverage a peak shaving estimation algorithm that produces a peak shave target for the battery energy storage system 20. Additionally or alternatively, the control module 74 may implement a closed-loop control that seeks to operate the battery energy storage system 20 and issues charging parameters, such as power limits to each respective charging station 22, with active sessions to maintain the power load from the grid interconnect 16 below a defined power value. As such, according to some examples, the charging system 12 may define one or more charging parameters (such as a maximum power limit) for one more charging stations 22 that supplies power to the EVs 14. For instance, based on the number of EVs 14 and the amount of available energy, the charging system 12 may manage the amount of power provided to each respective charging station 22 independently.

In some examples, the power load provided to each charging station 22 may be varied over time based on one or more factors. For instance, the power load provided may be based on the amount of time that an EV 14 receives energy from the charging station 22. Additionally or alternatively, the power load provided may be based on information provided by the modules of each EV 14. Additionally or alternatively, the power load provided may be at least partially based on the number of resources, the power load provided by the grid 18, and/or the amount of power stored within the battery energy storage system 20. The amount of power may further be varied based on the predictive models of upcoming changes in the number of EVs 14 that are to be operably coupled with the charging system 12. For example, if the power load provided by the grid 18 is less than the amount to be outputted to the one or more EVs 14, the computing system 50 may supplement the grid power with power from the battery energy storage system 20. Moreover, the power load provided from the grid 18 may be varied based on the energy cost for a defined period, which may be fifteen minutes or less.

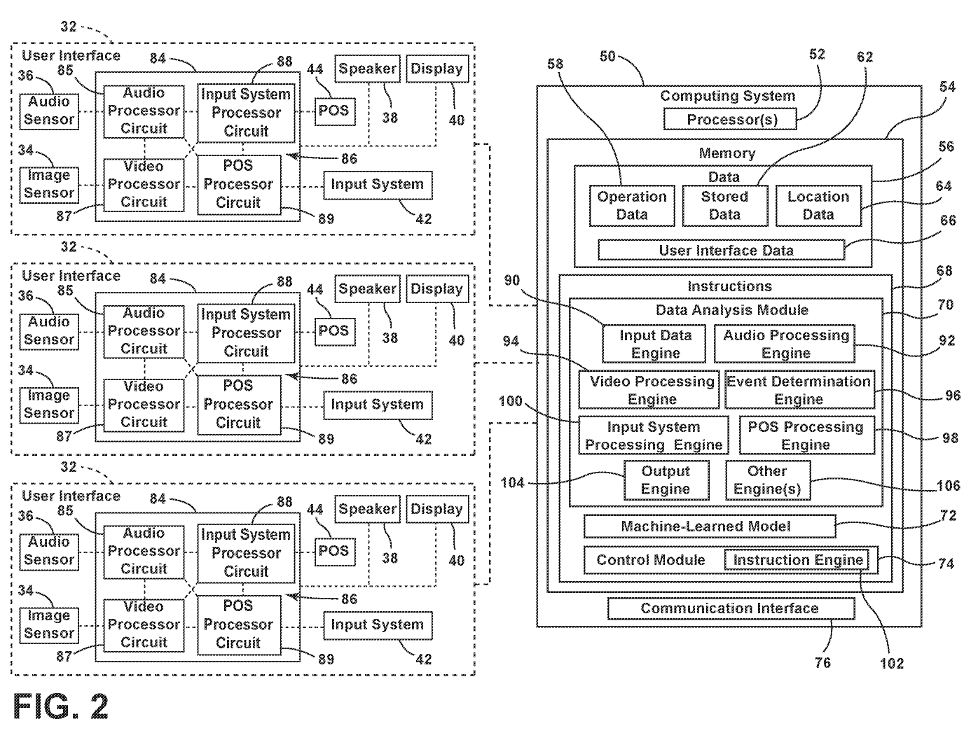

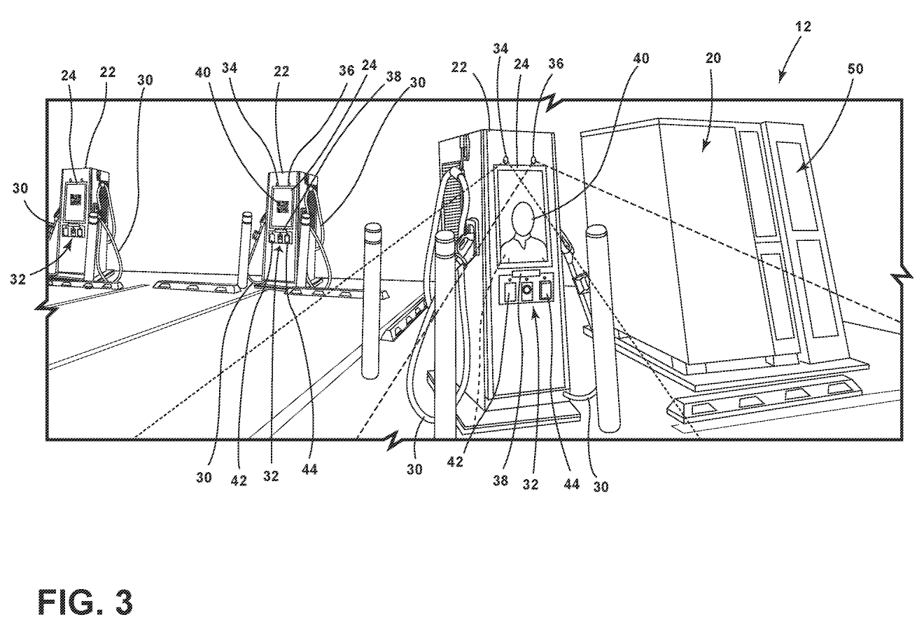

Referring now to FIGS. 2 and 3, the user interface 32 of each charging station 22 may include the image sensor 34, the audio sensor 36, the speaker 38, the display 40, the point of sale (POS) system 44, the input system 42, and/or any other device. The user interface 32 may allow for the charging system 12 to communicate with one or more persons or other objects while within a defined range of the charging system 12. Additionally or alternatively, one or more persons or other objects may communicate with the charging system 12 through the user interface 32 while within a defined range of the charging system 12.

In the examples illustrated in FIGS. 2 and 3, each charging station 22 may include a processor circuit 84 that may include one or more processing cores, and each core may have a respective different function. As an example, the processor circuit 84 may be a notional circuit that includes multiple different discrete processor circuits or cores that are coupled by an interconnect 86. In the examples of FIGS. 2 and 3, the processor circuit 84 includes an audio processor circuit 85, an image processor circuit 87, an input system processor circuit 88, and a POS processor circuit 89. The audio sensor 36 may be configured to capture audio data and provide audio signal information to the audio processor circuit 85. The image sensor 34 may receive image signals and provide image data to the image processor circuit 87. The input system 42 may receive one or more entries and provide the entry data to the input system processor circuit 88. Likewise, the POS system 44 may receive POS data and provide the POS data to the POS processor circuit 89. In various examples, the audio processor circuit 85, the image processor circuit 87, the input system processor circuit 88, and/or the POS processor circuit 89 may be separate hardware processor entities, while in other examples, the audio processor circuit 85, the image processor circuit 87, the input system processor circuit 88, and/or the POS processor circuit 89 may be software-implemented modules that are executed on the same or different processor circuit. In several examples, the audio processor circuit 85, the image processor circuit 87, the input system processor circuit 88, and/or the POS processor circuit 89 may be integrated together into a single device such as the processor circuit 84. In other examples, the audio processor circuit 85, the image processor circuit 87, the input system processor circuit 88, and/or the POS processor circuit 89 may be independent units communicatively coupled to each other using the interconnect 86.

In some examples, the audio sensor 36 may include one or more microphones, such as an array of microphones, configured to receive one or more audio input signals such as from an operator or various non-operator-based occurrences in an environment. For example, one or more signals from the audio sensor 36 may be processed for data generation.

In several examples, the image sensor 34 may be configured to capture image data of a defined environment. Moreover, the image sensor 34 may include an area-type image sensor, such as a CCD or a CMOS image sensor, and image-capturing optics that capture a particular field of view (FOV), which may form the boundary of the defined environment. In some cases, more than one image sensor 34 may be implemented. In such instances, the combined FOVs may form the defined environment. In various examples, the image sensor 34 may correspond to a stereographic camera having two or more lenses with a separate image sensor for each lens to allow the camera to capture stereographic or three-dimensional images. However, in alternative embodiments, the image sensors 34 may correspond to any other suitable sensing devices configured to capture image or image-like data, such as a LIDAR sensor, a RADAR sensor, and/or any other practicable sensor.

The user interface 32 may further include the display 40 for displaying graphics generated by the processor circuit 84. The display 40 may be configured as a light-emitting diode display (LED), an electroluminescent display (ELD), an electronic paper, E Ink, a plasma display panel (PDP), a liquid crystal display (LCD), a high-performance addressing display (HPA), a thin-film-transistor display (TFT), an organic light-emitting diode display (OLED), a Digital Light Processing display (DLP), a surface-conduction electron-emitter display (SED), a field emission display (FED), a laser display, carbon nanotubes, a quantum dot display (QLED), an interferometric modulator display (IMOD), a digital micro shutter display (DMS), a microLED, three-dimensional display, a holographic display, and/or any other type of display.

In various examples, the input system 42 may be in the form of keypads, touchpads, knobs, buttons, sliders, switches, and/or the like, which are configured to receive inputs from the operator. Additionally or alternatively, the input system 42 may be in the form of circuitry 224 to receive an input corresponding with a location over the display 40.

In several examples, the POS system 44 may include an access device (e.g., a POS terminal) that allows for information to be transferred between an operator of the charging station 22 and another party. The other party may be the owner of the charging station 22, a third party associated with the charging station 22, a service provider, a vendor, and/or any other party. In some cases, the POS terminal may allow monetary transactions and/or any other data transaction. For instance, the POS terminal may additionally or alternatively allow for loyalty/membership program application and verification. The loyalty/membership program application and verification may be associated with the operation of the charging station 22 and/or with any other vendor. In some cases, the monetary transaction may be at least partially determinative based on the verification of the loyalty/membership program.

The user interface 32 may further include the speaker 38 configured to generate one more audio signals generated by the processor circuit 84, such as including audible responses to operator inquiries. In some examples, the audio sensor 36, the audio processor circuit 85, and optionally the speaker 38, may be integrated into a single device, sometimes referred to as an audio assistant. For example, the image sensor 34, the image processor circuit 87, and optionally the display 40, may be integrated together into a single device, sometimes referred to as a video or an intelligent video device. For example, the intelligent video device may be communicatively coupled to an intelligent audio device using an interface such as the interconnect 86 that couples the processor circuits 84.

Artificial intelligence-based analysis of information from the image sensor 34 may be performed locally in the user interface 32 by the image processor circuit 87 or may be performed elsewhere, such as using the computing system 50. In some examples, the image processor circuit 87 and/or the computing system 50 may include or access data 56 configured to store, among other things, operation data, stored data, location data, entry data, etc. In operation, the image processor circuit 87 may receive video streams/images of a field of view from the image sensor 34 and convert each video stream into a plurality of static images or frames. The video streams/images may be processed either locally at the image processor circuit 87, and/or at the computing system 50, through one or more image analysis algorithms, such as machine learning and deep learning algorithms, for feature extraction from the image data including face information like facial features, angle or look direction, mood, etc. For example, the image processor circuit 87 may count or determine a number of people that are within a FOV of the image sensor 34 and use its artificial intelligence to determine who is present, who is talking, and respective look directions for the identified individuals.

Additionally or alternatively, the image processor circuit 87 may receive image data from the image sensor 34 and, by applying artificial intelligence processing, such as including applying a neural network-based analysis for feature extraction from the image data, the image processor circuit 87 may detect one or more objects in a sequence of images. The image processor circuit 87 may classify objects as one or more of a human, a pet, a vehicle, and/or any other object that may be present in a predefined zone within the field of view of the image sensor 34. For example, the image processor circuit 87 may track each object in a sequence of images to detect the motion of each object. Additionally or alternatively, if the detected object is a human being, then the image processor circuit 87 may perform a face recognition algorithm to identify the particular human being who is present in the environment, such as by comparing the facial attributes of the detected person with a database of known faces, which may be used to verify membership/loyalty membership and/or for any other purpose. The computing system 50 may be configured to follow various rules that define response behaviors to various detected and classified objects. Additionally or alternatively, an end operator or system owner may be automatically notified when a particular object or type of motion is detected in the monitored environment. Additionally or alternatively, a push notification may be provided if one or more defined actions occur, such as presumed damage to the charging station 22 and/or a defined object within the field of view of the image sensors 34. Additionally or alternatively, detection events that may trigger an alert may include, among other things, an unknown person or face, a human whose face is masked or is not visible, etc. As such, the computing system 50 may utilize the charging system 12 to provide security to an area surrounding the charging system 12. Additionally or alternatively, the computing system 50 may be configured to identify or implement artificial intelligence to learn about, various objects that are in the defined zone or portion of the monitored environment. In such instances, the computing system 50 may be configured to combine the image data with the audio data to determine a presence of a defined threat proximate to the charging network. The threat may be a person or object that is proximate to a vehicle 14, the charging system 12, and/or any other object within the field of view of the charging system. The threat may be an action that appears to removing an object within the field of view, breaking an object within the field of view, and causing any other negative effects to an object. The determination of a negative effect may be defined by the system and/or determined by the computing system 50 based on prior events. Additionally or alternatively, the charging system 12 may determine a make of a vehicle, a model of a vehicle, and/or any other information and preset one or more charging parameters for the vehicle based on the image data. In some cases, the image data may include other identifiable information that may be used to determine loyalty/membership verification and/or any other information. For example, the vehicle may include a license plate, a decal, and/or other uniquely identifiable information that may be used by the charging system 12 to tailor one or more outputs of the charging system 12 to the identified vehicle.

In some examples, the audio processor circuit 85 may, concurrently with the processing and analysis by the image processor circuit, process audio data from one or more operators, either locally or using the computing system 50. Thereafter, the processor circuit 84 and/or the computing system 50 may combine information about the image data with the audio data to decipher operator requests and actions and automatically service one or more operator requests.

In several examples, the processor circuit 84 may perform a voice recognition algorithm on audio signals received from the audio sensor 36. Voice recognition may include identifying a person from a characteristic of his or her voice. Voice recognition may be used to determine who is speaking and/or to determine what is being said. Identification of a person who is speaking may be referred to as “speaker recognition” and identification of what is being said may be referred to as “speech recognition”. For example, recognizing a speaking individual may simplify the task of translating speech in systems that have been trained on a specific individual's voice, or it may be used to authenticate or verify a speaker's identity. Speaker verification seeks to determine a 1:1 match where one speaker's voice is matched to one template whereas speaker identification seeks to determine a match from among N voice templates. In some examples, a recognition system may include two phases: enrollment and verification. During enrollment, an individual's voice is recorded and voice features (e.g., frequency components) are extracted to form a voice print, template, or model. In the verification phase, a speech sample or “utterance” is compared against a previously created voice print. For identification systems, the utterance is compared against multiple voice prints to determine a best match, while verification systems compare an utterance against a single voice print.

Additionally or alternatively, the speech recognition of the processor circuit 84 may be used as input data, which, in turn, is used by the computing system 50 to determine one or more outputs. For example, an operator may order one or more products or services (e.g., a coffee and a doughnut) through voice commands at the charging station 22 for one or more vendors that are within a defined distance of the charging system 12. In some cases, the one or more outputs may include confirmation of the items that are to be ordered and/or suggestions, such as products/services with reviews of a defined quality and/or pricing incentives for products/services.

Additionally or alternatively, the charging station 22 may initiate a conversation with an operator through the user interface 32. For instance, the charging station 22 may welcome the operator to the defined location. In addition, the user interface 32 may ask additional questions that elicit a response from the operator. In some instances, the charging station 22 may ask about an operator’s hunger level and suggest various products based on the elicited response and/or the image data. Moreover, the user interface 32 may suggest particular product types and/or brands within the specific product type. The user interface 32 may also provide additional instructions about any products/services that the operator may find relevant. If the operator provides additional information. New and updated outputs may be provided from the user interface 32, such as a second product/service type. The products/services may be provided by one or more vendors and/or any other party.

The computing system 50 may also receive POS data from the POS system 44 and/or entry data from the input system 42. The data from each of these components may be considered independently and/or in conjunction with the image data and/or audio data to generate one or more outputs based on a request from the operator. For example, an operator of the charging system 12 may vocally ask the charging station 22 if a building proximate to the charging station 22 has public bathrooms. In turn, the computing system 50 may determine an appropriate answer to and generate one or more outputs, which may instruct the speaker 38 to generate the audio signal about whether public bathrooms are or are not available. Additionally or alternatively, the one or more outputs may instruct the display 40 to illustrate an image showing the answer to the operator’s question and/or an image illustrating where the public restrooms are located. If the operator requests additional information, such as a quality of the restrooms, one or more additional outputs may be generated by the computing system 50. For example, the additional outputs may generate an audio signal summarizing reviews that may be outputted from the speakers 38 of the user interface 32, and/or an image related to the reviews may be illustrated on the display 40. In some cases, the operator may also inquire about the time remaining for charging their vehicle and/or any other charging or vehicle-related question. In turn, the computing system 50 and/or the charging station 22 may provide the requested information based on the status of the charging system 12, the vehicle, and/or any other information.

In some instances, the charging system 12 may provide additional services beyond charging, such as providing communication services for one or more operator devices. For instance, the charging station 22 may be capable of allowing an operator to authenticate their device and utilize their network to transfer data.

In some cases, the user interface 32 may ask for reviews of the charging experience, the charging system 12, a place of interest near the charging station 22, and/or related to any other operator experience. The data provided by the operator may be inputted into the computing system 50 and used to generate new outputs when relevant with regard to subsequent operator interactions. Moreover, the computing system 50 may generate additional outputs based on one or more defined types of information provided by an operator. For example, if the operator provides information related to a poor charging experience, a broken or defective component of the charging system 12, and/or other defined parameters, one or more outputs may be generated and provided to a remote source through the communication interface.

To further the conversation, the display 40 may provide an agent to the operator. The agent may be static and/or animated. In some cases, the agent may be a video of a human, a computer-generated character, a geometric shape, and/or any other image. In some cases, the agent may imitate human-like emotions, or any other movement, and/or may talk in a colloquial style during the conversation with the operator to provide a sense of vitality to the operator. Further, the agent may utilize memories (stored data) obtained from the past conversations to have natural-speech, and realistic conversations in the form of everyday conversations, questions, and answers. Further, the agent may select a voice tone and appropriate words based on the detected emotions of the operator.

Referring further to FIGS. 2 and 3, in various examples, the data analysis module 70 may include an entry data engine 90 (e.g., which may include the input system processor circuit 88), an audio processing engine 92 (e.g., which may include the audio processor circuit 85), a video processing engine 94 (e.g., which may include the image processor circuit 87), a POS processing engine 96 (e.g., which may include the POS processor circuit 89), an event determination engine 98, input processing engine 104, a output processing engine 100, instruction processing engine 102, and/or other engines 106. In some examples, the entry data engine 90 receives input data from the user interface 32, such as from the audio sensor 36 and/or from the image sensor 34. The input data includes a sequence of images of a video stream and associated audio signals (along with any input through the input device, the POS system 44, and/or any other device), such that the input data may be processed. For example, the audio processing engine 92 and the video processing engine 94 may process the audio signals and the video stream respectively. The input processing engine 104 and the POS processing engine 96 may process the inputted data and the POS data, respectively. In addition, the instruction processing engine 102 may generate one or more instructions for various components based on the one or more outputs from the data analysis module 70.

The video processing engine 94 may extract feature data from the input data to detect one or more objects in the respective images of the video stream. In various examples, the feature data may be extracted and evaluated locally (with data that is located within a defined range (e.g., 500 yards or any other defined distance) of the one or more charging stations 22) and substantially in real-time (e.g., with low latency, which can be within a delay of less than five (5) seconds and/or any other defined amount of time) with the capture of a sequence of images to improve efficiency of the system. In several examples, the video processing engine 94 may perform processing to extract features of a still image or of a series of images to detect objects and determine shape and size information about one or each object in a particular image. For example, the feature extraction may be a type of dimensionality reduction that efficiently represents parts of an image as a compact feature vector. For example, a reduced feature representation may be used to complete tasks such as image matching and retrieval, which may be completed locally by the computing system 50 and/or the charging station 22. Feature detection, feature extraction, and matching may be combined to perform object detection and recognition, content-based image retrieval, face detection, and recognition, or texture classification, etc.

In numerous examples, object detection in one or more images may be performed by the video processing engine 94 using a deep learning model. Deep learning may include an artificial intelligence processing technique that learns tasks and feature representations from image and image data and, in some examples, is implemented using neural networks such as Convolutional Neural Networks (CNNs). A deep learning model may be used to locate or classify one or more objects in images and video streams. In various examples, using a deep learning-based object classifier, the video processing engine 94 may categorize detected objects. The categories may include, but are not limited to, vehicles, humans, pets, devices, other objects, and the like. Though techniques for feature extraction and object detection are explained herein as including or using a deep learning model, any other suitable technique for feature extraction and object detection may similarly be used.

When a detected object is determined by the video processing engine 94, to be a human, then the video processing engine 94 may perform a face recognition algorithm, such as using deep learning and neural networks, to identify the human. The face recognition technique may identify or verify the human in an image such as by comparing facial features from the image with faces stored within a database, which in some examples may be configured by an operator. For example, the video processing engine 94 may determine face information and various facial features, the angle or look direction of a human, a mood of a human, and/or any other characteristic. For example, the video processing engine 94 may determine a number of people, objects, or other features in a monitored environment. For example, the video processing engine 412 may determine various activities of one or more humans in the monitored environment using its deep learning or other artificial intelligence capabilities.

In various examples, the video processing engine 94 may track one or more detected objects in a sequence of images or frames to determine the motion of the detected objects. To perform tracking, the video processing engine 94 may analyze sequential images and may provide information about changes or movement of the objects among the images. For example, the video processing engine 94 may perform target representation and localization, filtering, and/or data association to perform object tracking. The video processing engine 94 may optionally determine attributes or characteristics of each detected object, for example including but not limited to shape, size, color, and the like. In turn, this data may be used to determine one or more attributes of a vehicle that may operably couple with the charging station 22.

The audio processing engine 92 may process audio commands received or detected by the audio sensor 36. For example, the computing system 50 may be configured to perform tasks or services for an operator such as by using natural language processing (NLP) to match an operator's voice input to executable commands and may provide an audible response to the operator through an output device such as the speaker 38, or provide some other system response. The audio processing engine 92 may continually learn using artificial intelligence techniques including machine learning and deep learning.

For example, the event determination engine 98 may be used to determine an event by comparing attributes of one or more detected objects or audio events with pre-defined rules, such that when an event is determined a notification may be sent to the operator using the output processing engine 100. For example, a rule may be defined for a particular object that if the particular object is not detected in an image, then the particular object may be termed as a “missing object” and a notification may be sent to an operator using the output processing engine 100. For example, the audio processing engine 92, the video processing engine 94, and the event determination engine 214 may be used together to determine, e.g., missing objects, intrusion by an unidentified person, or other events that may trigger a notification to an operator.

The output processing engine 100 may be configured to determine one or more outputs. In turn, the instruction processing engine 102 may generate instructions for the speaker 38, the display 40, and/or any other component based on the inputted data.

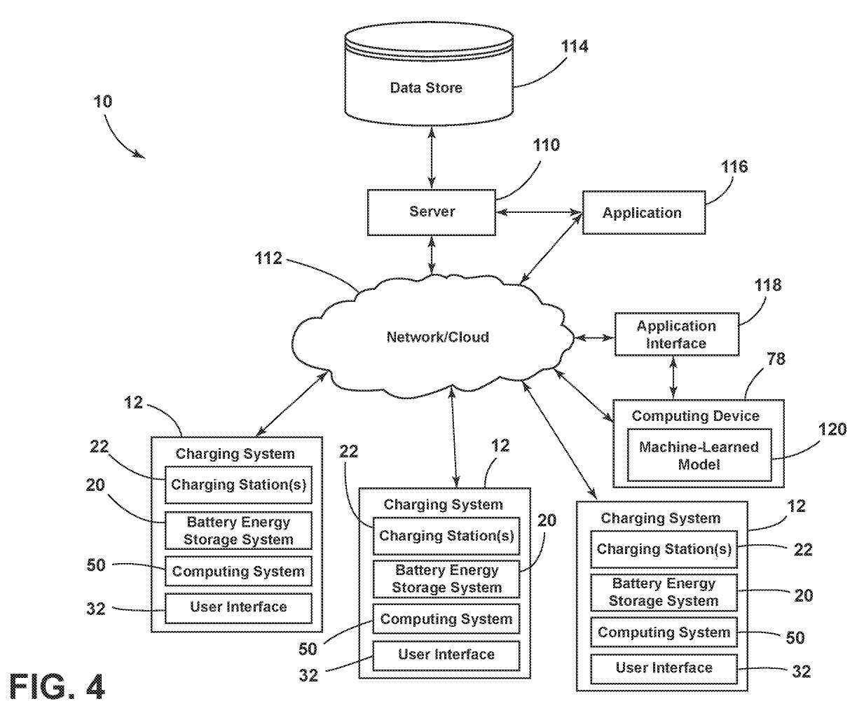

Referring now to FIG. 4, in some examples, the charging network 10 is illustrated in accordance with various aspects of the present disclosure. While the charging network 10 described with reference to FIGS. 2 and 3 performs one or more functions (e.g., performing the methods, steps, algorithms, calculations, and the like disclosed herein) locally (with data that is located within a defined range (e.g., 500 yards or any other defined distance) of the one or more charging stations 22) and substantially in real-time (e.g., with low latency, which can be within a delay of less than five (5) seconds and/or any other defined amount of time), in some examples, each of the charging systems 12 may be communicatively coupled with one or more remote sites, such as a remote server 110 via a network/cloud 112 to provide data and/or other information therebetween. Any of the functions (e.g., performing the methods, steps, algorithms, calculations, and the like disclosed herein) described herein with reference to any figure may be performed at a charging system 12, a computing system 50, a charging system 12, and/or a remote server without departing from the scope of the present disclosure. The network/cloud 112 represents one or more systems by which the charging systems 12 and/or the computing device 78 may communicate with the remote server 110. The network/cloud 112 may be one or more of various wired or wireless communication mechanisms, including any desired combination of wired and/or wireless communication mechanisms and any desired network topology (or topologies when multiple communication mechanisms are utilized). Example communication networks include wireless communication networks (e.g., using Bluetooth, IEEE 802.11, etc.), local area networks (LAN), and/or wide area networks (WAN), including the Internet and the Web, which may provide data communication services and/or cloud computing services. The Internet is generally a global data communications system. It is a hardware and software infrastructure that provides connectivity between computers. In contrast, the Web is generally one of the services communicated via the Internet. The Web is generally a collection of interconnected documents and other resources, linked by hyperlinks and URLs. In many technical illustrations when the precise location or interrelation of Internet resources is generally illustrated, extended networks such as the Internet are often depicted as a cloud (e.g. 112 in FIG. 4). The verbal image has been formalized in the newer concept of cloud computing. The National Institute of Standards and Technology (NIST) provides a definition of cloud computing as “a model for enabling convenient, on-demand network access to a shared pool of configurable computing resources (e.g., networks, servers, storage, applications, and services) that may be rapidly provisioned and released with minimal management effort or service provider interaction.” Although the Internet, the Web, and cloud computing are not the same, these terms are generally used interchangeably herein, and they may be referred to collectively as the network/cloud 112.

The server 110 may be one or more computer servers, each of which may include at least one processor and at least one memory, the memory storing instructions executable by the processor, including instructions for carrying out various steps and processes. The server 110 may include or be communicatively coupled to a data store 114 for storing collected data as well as instructions for the one or more charging systems 12 with or without intervention from an operator, the charging systems 12, and/or the computing device 78. Moreover, the server 110 may be capable of analyzing input or raw data received from the one or more charging systems 12 and final or post-processing data (as well as any intermediate data created during data processing). Accordingly, the instructions provided to any one or more of the charging systems 12 may be determined and generated by the server 110 and/or one or more cloud-based applications 116.

With further reference to FIG. 4, the server 110 may also generally implement features that may enable the charging systems 12 (e.g., the charging stations 22 and/or the computing system 50) to communicate with cloud-based applications 116. Communications from the charging systems 12 may be directed through the network/cloud 112 to the server 110 and/or cloud-based applications 116 with or without a networking device, such as a router and/or modem. Additionally, communications from the cloud-based applications 116, even though these communications may indicate one of the charging systems 12 as an intended recipient, may also be directed to the server 110. The cloud-based applications 116 are generally any appropriate services or applications 116 that are accessible through any part of the network/cloud 112 and may be capable of interacting with the charging systems 12.

In various examples, the charging systems 12 may be feature-rich with respect to communication capabilities, i.e. have built-in capabilities to access the network/cloud 112 and any of the cloud-based applications 116 or may be loaded with, or programmed to have such capabilities. The charging systems 12 may also access any part of the network/cloud 112 through industry-standard wired or wireless access points, cell phone cells, or network nodes. In some examples, operators may register through the charging systems 12, which is provided to the server and may provide access to the charging systems 12 and/or thereby allow the server 110 to communicate directly or indirectly with the charging systems 12. According to some examples, the charging systems 12 may be preconfigured at the time of manufacture with a communication address (e.g. a URL, an IP address, etc.) for communicating with the server 110 and may or may not have the ability to upgrade or change or add to the preconfigured communication address.

Referring still to FIG. 4, when a new cloud-based application 116 is developed and introduced, the server 110 may be upgraded to be able to receive communications for the new cloud-based application 116 and to translate communications between the new protocol and the protocol used by the charging systems 12. The flexibility, scalability, and upgradeability of current server technology render the task of adding new cloud-based application protocols to the server 110 relatively quick and easy.

In several embodiments, an application interface 118 may be operably coupled with the cloud 112 and/or the application 116. The application interface 118 may be configured to receive data related to one or more charging systems 12. In some examples, at various predefined periods and/or times, the charging systems 12 may communicate with the server 110 through the network/cloud 112 to obtain the stored instructions, if any exist. Upon receiving the stored instructions, the charging systems 12 may implement the instructions.

In some instances, a computing device 78 may also access the server 110 to obtain information related to stored events. The computing device 78 may be a mobile device, tablet computer, laptop computer, desktop computer, watch, virtual reality device, television, monitor, or any other computing device 78 or another visual device. In some instances, the computing device 78 may implement a machine-learned model 120. The computing device 78 may be utilized by a third-party that is associated with the charging system 12. For example, if the charging system 12 is implemented within a parking lot of a retail store (or other third party, e.g., product retailer/service provider), the computing device 78 may be accessible by the retail store or other third party. In such instances, the application interface that is accessible through the computing device 78 may allow for various outputs to be inputted by the third party. The third-party may provide any other instructions that may be used to determine one or more outputs of the charging system 12 within a defined location and based on the inputs provided by an operator of the charging system 12.

In addition, in various embodiments, the data used by the charging network 10, the charging system 12, the charging station 22, the user interface 32, the remote server 110, the data store 114, the application 116, the application interface 118, the computing device 78, and/or any other component described herein for any purpose may be based on data provided by the charging network 10, an operator of the charging network 10, and/or third-party data that may be converted into comparable data that may be used independently or in conjunction with data collected from the charging network 10 and/or an operator of the charging network 10.

In some examples, the charging system 12 may receive a first set of the image data and/or a first set of the audio data. In addition, the charging system 12 may determine a first set of one or more outputs based at least on the first set of the image data and the first set of the audio data. The determination of the first set of one or more outputs may be determined and generated locally. In turn, the charging system 12 may generate a first set of one or more instructions based on the first set of one or more outputs. In some instances, the instructions may instruct a display 40 to illustrate an animated graphic that provides a response to an input from an operator of the charging station 22. Additionally or alternatively, in some instances, the instructions may instruct a speaker 38 to generate an audio signal that provides a response to an input from an operator of the charging station 22. Additionally or alternatively, in some instances, the instructions may instruct a display 40 to generate an illustration of a suggested product or service in response to an input from an operator of the charging station 22.

In some examples, the charging system 12 may also receive a second set of the image data after the first set of the image data and a second set of the audio data after the first set of the audio data. The charging system 12 may determine a second set of one or more outputs based at least on the first set of one or more outputs, the second set of the image data, and the second set of the audio data. In turn, the computing system 50 may generate a second set of one or more instructions based on the second set of one or more outputs. As provided above, in some instances, the instructions may instruct a display 40 to illustrate an animated graphic that provides a response to an input from an operator of the charging station 22. Additionally or alternatively, in some instances, the instructions may instruct a speaker 38 to generate an audio signal that provides a response to an input from an operator of the charging station 22. Additionally or alternatively, in some instances, the instructions may instruct a display 40 to generate an illustration of a suggested product or service in response to an input from an operator of the charging station 22. Additionally or alternatively, the instructions may further be configured to instruct the charging station 22 to transmit at least one of the first set of one or more outputs or the second set of one or more outputs is to a third party. Likewise, based on the transmission of the at least one of the first set of one or more outputs or the second set of one or more outputs to the third party, the charging system 12 may receive third-party data. However, the third-party data may be received by the charging system 12 before transmitting any data to the third party. For example, if a user requests a menu from a restaurant proximate to the charging station 22, the charging system 12 may present the menu of that restaurant to the operator. In turn, if the operator requests to order an item from that restaurant, the order may be completed through the charging station 22. Once the order is received, the charging station 22 may transmit the order to the defined restaurant. In some cases, the charging station 22 may request data from the third-party before placing the order. For instance, the charging system 12 may be configured to determine an estimated completion time for an order. In turn, the charging system 12 may use such data for any additional outputs, such as providing such information and/or a comparison of order time to charging time to the operator. Additionally or alternatively, a financial transaction for the desired products may be completed through the user interface 32, such as through the POS system 44 of the charging system 12.

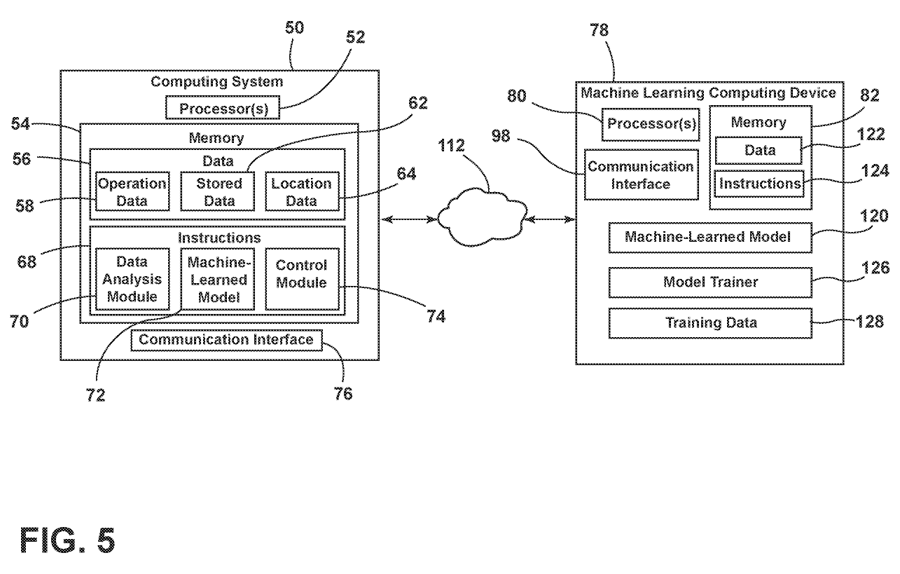

Referring now to FIG. 5, according to some aspects of the present disclosure, the computing system 50 may store or include one or more models, which may be machine-learned models 72. For example, the machine-learned model 72 may be a machine-learned user interface 32 output model. In various examples, the machine-learned user interface 32 output model may be configured to receive input data from the user interface 32 and process the input data to determine one or more outputs. The one or more outputs may be provided to the control module 74, which in turn generates instructions for various components of the user interface 32, such as the display 40 and/or the speaker 38.

In some examples, one or more of the models, which may be implemented by any module, may correspond to a linear machine-learned model. For instance, one or more of the models may be or include a linear regression model. A linear regression model may be used to intake the input data from the charging system(s) 12 and provide intermittent or continuous outputs for the charging stations 22 and/or the computing system 50. Linear regression models may rely on various techniques, such as ordinary least squares, ridge regression, lasso, gradient descent, and/or the like. However, in other embodiments, one or more of the models may be or include any other suitable linear machine-learned model.

Alternatively, one or more of the models 72, 120 may correspond to a non-linear machine-learned model. For instance, one or more of the models may be or include a neural network such as, for example, a convolutional neural network. Example neural networks include feed-forward neural networks, recurrent neural networks (e.g., long short-term memory recurrent neural networks), convolutional neural networks, transformer neural networks (or any other models that perform self-attention), or other forms of neural networks. Neural networks may include multiple connected layers of neurons and networks with one or more hidden layers, which may be referred to as “deep” neural networks. Typically, at least some of the neurons in a neural network include non-linear activation functions.

As further examples, one or more of the models may be or may otherwise include various other machine-learned models, such as a support vector machine; one or more decision-tree-based models (e.g., random forest models); a Bayes classifier; a K-nearest neighbor classifier; and/or other types of models including both linear models and non-linear models.

In some embodiments, the computing system 50 may receive the one or more machine-learned models 72, 120 from the computing device 78 over the network/cloud 112 and may store the one or more machine-learned models 72 in the memory 54. The computing system 50 may then use or otherwise run the one or more machine-learned models 72 (e.g., by processors 52) locally (with data that is located within a defined range (e.g., 500 yards or any other defined distance) of the one or more charging stations 22) and substantially in real-time (e.g., with low latency, which can be within a delay of less than five (5) seconds and/or any other defined amount of time).

The machine learning computing device 78 includes one or more processors 80 and memory 82. The one or more processors 80 may be any suitable processing device such as described with reference to processors 52. The memory 82 may include any suitable storage device such as described with reference to memory 54. The memory 82 may store information that may be accessed by the one or more processors 80. For instance, the memory 82 (e.g., one or more non-transitory computer-readable storage mediums, memory devices) may store data 122 that may be obtained, received, accessed, written, manipulated, created, and/or stored. In some embodiments, the machine learning computing device 78 may obtain data from one or more memory device(s) that are remote from the computing device 78.

The memory 82 may also store computer-readable instructions 124 that may be executed by the one or more processors 80. The instructions 124 may be software written in any suitable programming language or may be implemented in hardware. Additionally, or alternatively, the instructions 124 may be executed in logically and/or virtually separate threads on the processors 80. For example, the memory 82 may store instructions 124 that when executed by the one or more processors 80 cause the one or more processors 80 to perform any of the operations and/or functions described herein.

In some embodiments, the machine learning computing device 78 includes one or more server computing devices. If the machine learning computing device 78 includes multiple server computing devices, such server computing devices may operate according to various computing architectures, including, for example, sequential computing architectures, parallel computing architectures, or some combination thereof.

In addition or alternatively to the models 72 at the computing system 50, the machine-learning computing device 78 may include one or more machine-learned models 120. For example, the model 120 may be the same as described above with reference to the models 72.

In some embodiments, the machine learning computing device 78 may communicate with the computing system 50 according to a client-server relationship. For example, the machine-learning computing device 78 may implement the machine-learned model 120 to provide a web-based service to the computing system 50. For example, the web-based service may provide data analysis for determining a charge/discharge command for the battery energy storage system 20 and/or one or more charging parameters for respective charging stations 22.

Thus, machine-learned models 72 may be located and used at the computing system 50, and/or machine-learned models 120 may be located and used at the machine-learning computing device 78.

In some examples, the machine learning computing device 78 and/or the computing system 50 may train the machine-learned models 72, 120 through the use of a model trainer 126. The model trainer 126 may train the machine-learned models 72, 120 using one or more training or learning algorithms. One example training technique is the backward propagation of errors (“backpropagation”), or other training techniques may be used. In some embodiments, the model trainer 126 may perform supervised training techniques using a set of training data 128. For example, the training data 128 may include operational data from the charging systems 12 that is associated with a known value for the target parameter (e.g., a known response to an input). For instance, operational data associated with the training dataset 128 may be continuously collected, generated, and/or received while the charging system 12 is being used to provide matching or correlation datasets between the data analysis module 70 and the input data. The model trainer 126 may perform several generalization techniques to improve the generalization capability of the models being trained. Generalization techniques include weight decays, dropouts, or other techniques. The model trainer 126 may be implemented in hardware, software, firmware, or combinations thereof.

Thus, in some embodiments, the models may be trained at a centralized computing system (e.g., at “the factory”) and then distributed to (e.g., transferred to for storage by) specific controllers through a communications interface 76. Additionally or alternatively, the models may be trained (or re-trained) based on additional training data generated by operators of the system. This process may be referred to as the “personalization” of the models and may allow operators to further train the models to provide improved (e.g., more accurate) predictions for unique field and/or machine conditions experienced by such operators.

FIGS. 1-5 illustrates example computing systems that may be used to implement the present disclosure. Other computing systems may be used as well. For example, in some embodiments, the computing system 50 may include the model trainer 126 and the training dataset 128. In such embodiments, the machine-learned models 72 may be both trained and used locally at the computing system 50. As another example, in some embodiments, the computing system 50 is not connected to other computing systems.

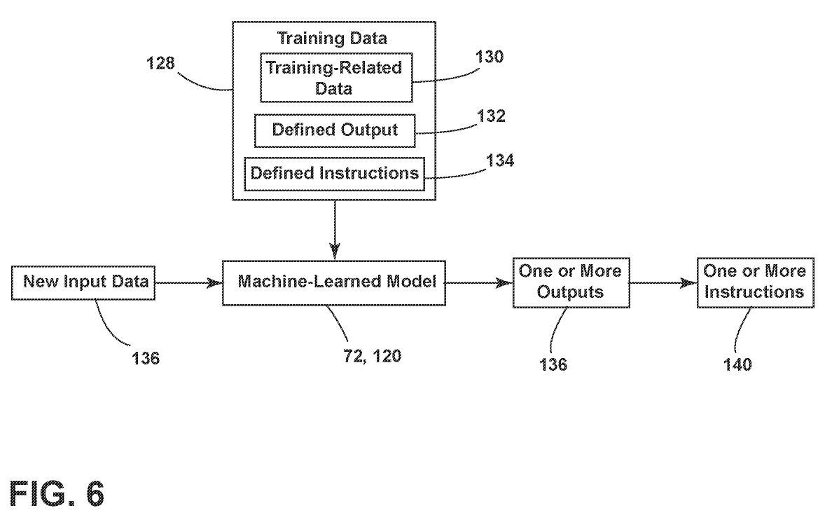

Referring now to FIG. 6, a schematic view illustrating a flow diagram for training a machine-learned model 72, 120, such as the machine-learned user interface output model described above, is illustrated in accordance with aspects of the present subject matter. As indicated above, the models 72, 120 may be trained by a model trainer 126 that uses training data 128 and performs any suitable supervised and/or unsupervised training techniques. In several embodiments, as shown in FIG. 6, the models 72, 120 may be trained using one or more training datasets 128 including input data 130 that is associated with a known value for the defined output 132 and, in turn, the defined instructions 134. For instance, the defined outputs associated with the training dataset 128 may be continuously collected, generated, and/or received (e.g., via the charging station 22, the computing system 50, and/or another device). In turn, the control module 74 may provide instructions to operate the user interface 32, and/or any other component, in accordance with the one or more outputs.

By analyzing the input data 130 in combination with the known or defined outputs, suitable correlations may be established between the data (including certain subsets of the data) and the defined outputs to develop a machine-learned model 72, 120 that may accurately predict the output based on new datasets including the same type of data. For instance, in some implementations, suitable correlations may be established between the user interface 32 input and a defined output.

As shown in FIG. 6, once the machine-learned model 72, 120 has been trained, new datasets 136 may be input into the model to allow the model to predict or determine new outputs based on the received inputs. For instance, upon training the model, the data collected, generated, and/or received may be input into the model to determine one or more outputs 138, which in turn, are used to generate one or more instructions 140 for operating a component of the charging system 12. For instance, the model may be used to determine subsequent outputs by applying inferences from previous inputs and/or making logic-based inferences based on the training data. For example, when an operator interacts with the user interface 32, the model may generate one or more outputs. Based on the operator’s response to the outputs, the model may be updated for subsequent interactions. As provided herein, the input data may include image data from the image sensor 34, sound data from the microphone, inputted data through the input device, payment data based on usage of a POS system 44, and/or any other data.

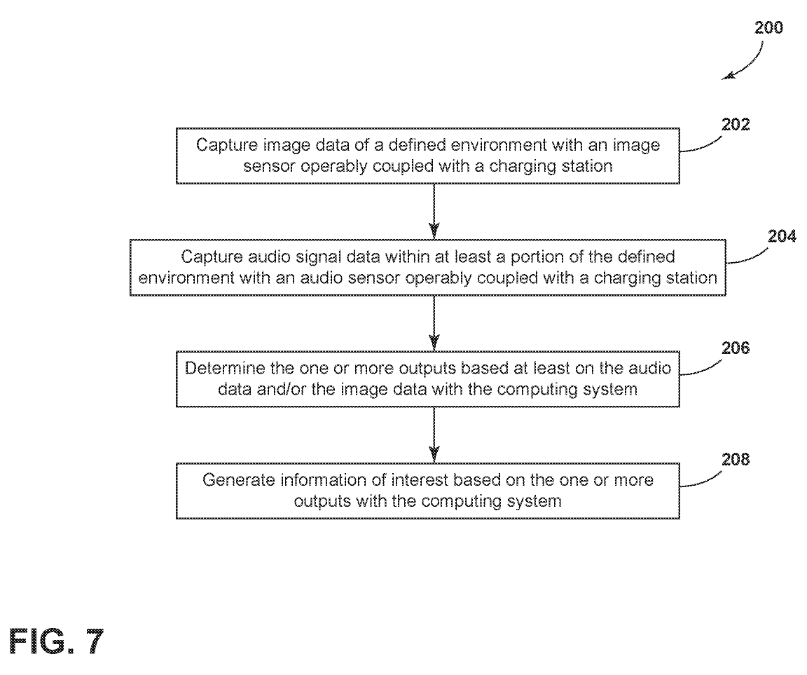

Referring now to FIG. 7, a method 200 for operating a charging network is illustrated in accordance with aspects of the present subject matter. In general, the method 200 will be described herein with reference to the charging network and one or more charging systems described above with reference to FIGS. 1-6. However, the disclosed method 200 may generally be utilized with any suitable system. In addition, although FIG. 7 depicts steps performed in a particular order for purposes of illustration and discussion, the methods discussed herein are not limited to any particular order or arrangement. One skilled in the art, using the disclosures provided herein, will appreciate that various steps of the methods disclosed herein may be omitted, rearranged, combined, and/or adapted in various ways without deviating from the scope of the present disclosure.

As illustrated in FIG. 7, at (202), the method 200 may include capturing image data of a defined environment with an image sensor operably coupled with a charging station. Additionally or alternatively, at (204), the method 200 may include capturing audio data within at least a portion of the defined environment with an audio sensor that may be operably coupled with a charging station.

At (206), the method 200 may include determining one or more outputs based at least on the image data and/or the audio data with a local computing system. At (208), the method may include generating instructions based on the one or more outputs with the computing system. In some instances, the instructions may instruct a display to illustrate an animated graphic that provides a response to an input from an operator of the charging station. Additionally or alternatively, in some instances, the instructions may instruct a speaker to generate an audio signal that provides a response to an input from an operator of the charging station. Additionally or alternatively, in some instances, the instructions may instruct a display to generate an illustration of a suggested product or service in response to an input from an operator of the charging station.

In various examples, the method 200 may implement machine learning methods and algorithms that utilize one or several vehicle learning techniques including, for example, decision tree learning, including, for example, random forest or conditional inference trees methods, neural networks, support vector machines, clustering, and Bayesian networks. These algorithms may include computer-executable code that may be retrieved by the computing system and/or through a network/cloud and may be used to evaluate and update an amount of movement of the actuators. In some instances, the vehicle learning engine may allow for changes to the actuators to be performed without human intervention.

It is to be understood that the steps of any method disclosed herein may be performed by a computing system upon loading and executing software code or instructions that are tangibly stored on a tangible computer-readable medium, such as on a magnetic medium, e.g., a computer hard drive, an optical medium, e.g., an optical disc, solid-state memory, e.g., flash memory, or other storage media known in the art. Thus, any of the functionality performed by the computing system described herein, such as any of the disclosed methods, may be implemented in software code or instructions that are tangibly stored on a tangible computer-readable medium. The computing system loads the software code or instructions via a direct interface with the computer-readable medium or via a wired and/or wireless network. Upon loading and executing such software code or instructions by the controller, the computing system may perform any of the functionalities of the computing system described herein, including any steps of the disclosed methods.

The term "software code" or "code" used herein refers to any instructions or set of instructions that influence the operation of a computer or controller. They may exist in a computer-executable form, such as vehicle code, which is the set of instructions and data directly executed by a computer's central processing unit or by a controller, a human-understandable form, such as source code, which may be compiled to be executed by a computer's central processing unit or by a controller, or an intermediate form, such as object code, which is produced by a compiler. As used herein, the term "software code" or "code" also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A charging network comprising:
a charging station configured to electrically couple a vehicle with a power source, the charging station comprising:
a housing; and
a user interface operably coupled with the housing, the user interface comprising:
an image sensor configured to capture image data of a defined environment;
an audio sensor configured to capture audio data; and
a display; and
a computing system operably coupled with the user interface, the computing system including a processor and associated memory, the memory storing instructions that, when implemented by the processor, configure the computing system to:
receive the image data and the audio data;
determine one or more outputs based at least on the image data and the audio data; and
generate one or more instructions for the display based on the one or more outputs, the one or more instructions causing the display to illustrate a defined graphic.

2. The charging network of claim 1, wherein the computing system is located locally within the charging network.

3. The charging network of claim 1, wherein the computing system implements a machine-learned model to determine the one or more outputs.

4. The charging network of claim 1, wherein the charging station further comprises:
a speaker configured to generate one more audio signals, and wherein the computing system is further configured to generate one or more instructions for the speaker based on the one or more outputs.

5. The charging network of claim 1, wherein the audio sensor is operably coupled with an audio processor circuit that performs natural language processing of the audio data.

6. The charging network of claim 5, wherein the image sensor is operably coupled with an image processor circuit configured to extract one or more features from the image data, and wherein the computing system is configured to detect one or more objects based on the one or more features.

7. The charging network of claim 6, wherein the computing system is further configured to classify the one or more objects of the image sensor, and wherein the classification of the objects are inputs for the computing system.

8. The charging network of claim 6, wherein the audio processor circuit is configured to process audio data concurrently with the processing of the image data by the image processor circuit.

9. The charging network of claim 6, wherein the computing system is further configured to combine the image data with the audio data to determine an operator request.

10. The charging network of claim 6, wherein the computing system is further configured to combine the image data with the audio data to determine a presence of a defined threat proximate to the charging network.

11. The charging network of claim 1, wherein the charging station further comprises:
a power distribution assembly; and
a power output cable electrically coupled with the power distribution assembly, wherein a charging parameter is based at least in part on the image data or the audio data.

12. A method for operating a charging network, the method comprising:
capturing, with an image sensor operably coupled with a charging station, image data of a defined environment;
determining, with a local computing system, one or more outputs based at least on the image data; and
generating, with the computing system, instructions based on the one or more outputs.

13. The method for operating a charging network of claim 12, further comprising:
capturing, with an audio sensor operably coupled with a charging station, audio data within at least a portion of the defined environment; and
determining, with the computing system, the one or more outputs based at least on the audio data in combination with the image data.

14. The method for operating a charging network of claim 12, wherein the instructions instruct a display to illustrate an animated graphic that provides a response to an input from an operator of the charging station.

15. The method for operating a charging network of claim 12, wherein the instructions instruct a speaker to generate an audio signal that provides a response to an input from an operator of the charging station.

16. The method for operating a charging network of claim 12, wherein the instructions instruct a display to generate an illustration of a suggested product or service in response to an input from an operator of the charging station.

17. A charging network comprising:
a charging station configured to electrically couple a vehicle with a power source, the charging station comprising:
a housing; and
a user interface operably coupled with the housing, the user interface comprising:
an image sensor configured to capture image data of a defined environment;
an audio sensor configured to capture audio data;
a display configured to illustrate one or more images; and
a speaker configured to generate one more audio signals; and
a computing system operably coupled with the user interface, the computing system including a processor and associated memory, the memory storing instructions that, when implemented by the processor, configure the computing system to:
receive a first set of the image data and a first set of the audio data;
determine a first set of one or more outputs based at least on the first set of the image data and the first set of the audio data; and
generate a first set of one or more instructions based on the first set of one or more outputs, wherein the first set of one or more instructions cause the display to illustrate a defined graphic or the speaker to output an audio signal.

18. The charging network of claim 17, further comprising:
an input system operably coupled with the user interface and the housing, the input system configured to receive input data from the operator, and wherein the computing system is further configured to receive the input data and determine one or more outputs based at least in part on the input data.

19. The charging network of claim 17, wherein the computing system is further configured to:
receive a second set of the image data after the first set of the image data and a second set of the audio data after the first set of the audio data;
determine a second set of one or more outputs based at least on the first set of one or more outputs, the second set of the image data, and the second set of the audio data; and
generate a second set of one or more instructions based on the second set of one or more outputs, wherein the one or more instructions cause the display to illustrate a defined graphic or the speaker to output an audio signal.

20. The charging network of claim 19, wherein the computing system is further configured to transmit at least one of the first set of one or more outputs or the second set of one or more outputs is transmitted to a third party.
